(19) United States
(12) Patent Application Publication
(10) Pub. No.: US 2013/0062484 A1
(43) Pub. Date: Mar. 14, 2013

(54) Reusable hanger that inserts and removes from a mounting surface without tools

(71) Applicant: Gordon Murphy, Kalama, OR (US)

(72) Inventor: Gordon Murphy, Kalama, OR (US)

(73) Assignee: CTZ Global, LLC, Las Vegas, NV (US)

(21) Appl. No.: 13/199,924

(22) Filed: Sep. 14, 2011

(51) Int. Cl. F16B 45/00

(52) U.S. Cl. 248/218.1

(57) ABSTRACT

A reusable hanger that inserts and removes from a mounting surface without tools comprising a metal shank having a point on one end and a hook on the other, with a specially formed detent medially located between the point and the hook, and a flange that encases the detent and fixates to the shank. The detent provides improved adhesion between the flange and the shank, while further providing a sheer point along the shank, thereby reducing damage to the supporting surface if a user overloads the hook. The flange serves several purposes, it is the finger push location for the user to install the hanger without tools by pushing and/or twisting the flange such that the point pierces the support surface and inserts until the flange stops flush against the support surface. Once flush, the flange provides compressive support structure between the support surface and the shank, thereby increasing loading capacities of the hook. When being removed without tools, the flange provides finger twist and pull location that enables the user to remove the hanger leaving only a small hole matching the shank. Once removed, the hanger is ready to be used again.

### TECHNICAL FIELD

The present invention relates to hangers for supporting objects from surfaces such as sheetrock walls or corkboards, and easily inserted and removed by hand.

### BACKGROUND OF THE INVENTION

Hangers made of wire that are insertable on the shank end having a formed hook on the other are common in the prior art, and commonly used for suspending objects. Such hangers generally are formed with a threaded screw portion that is twist driven into the support surface to engage the hanger in place. If the support surface is brittle, like dry wall or plasterboard, the threaded shank causes substantial damage when installed or relocated, leaving an undesirable hole or blemish when removed. Further, the force to twist these threaded hangers is significant, and not all users will have the strength to properly install threaded hangers. Finally, threaded shanks when overloaded can tear out of supporting surfaces causing significant damage, whereas smooth shanks cause less damage.

While such heavy-duty hanger systems having threaded shanks are effective for the purpose of supporting significant weight, lightweight objects, such as the vines of houseplants, key rings, photos, Christmas lights and the like, do not weigh as much, and do not require as much support. If the shank is inserted without threads to reduce the hole or blemish in the supporting surface, the hanger is prone to drooping down when weight is applied, or pulling out all together. Adding a flange between the smooth shank and the hook and inserting the shank into the support surface until the flange is flush and in contact with the support surface, prevents drooping, and greatly increases the support strength without the damaging and difficult to install threads on the shank portion.

Previously available hangers that require no tools to install failed to be reusable, and often structurally failed when being installed. Common problems included the flange not staying secured to the shank when being inserted, or the flange not staying secured to the shank when removed, or falling off all together if the hanger was reused. Indeed, another noticeably absent feature in the prior art is a solution to overloading of the hanger, a shank hook hanger with a sheer point that protects the supporting surface from overloading damage, a reusable hanger that solves the aforementioned problems is desired.

An object of the present invention is the provision of a hanger system which can be quickly and conveniently used for securing items to walls or other vertically disposed supporting surfaces.

A further object of the invention is the provision of a recyclable product that will provide a lifetime of use if reused correctly.

Another object of the invention is the provision of having minimal damage to the supporting surface.

Another object of the invention is the sheer point provision to reduces damage to the supporting surface if the hook is overloaded.

Another object of the invention is the provision that the flange is fixedly secured to the shank such that pushing and twisting during hanger install or pulling and twisting during hanger removal does not pull or tear the flange from the shank.

A final object of the invention is the provision that the flange be specially sized and shape so as to provide users with disabilities sufficient surface area and ergonomic grip points to install and uninstall the hanger in sheetrock walls.

Still further objects and advantages of the invention will be set forth in this specification, and in part will be obvious through description, or may be learned while practicing the invention. The objects and advantages are realized and attained by means of instrumentalities and combinations particularly pointed out in the claims that follow.

### RELATED PRIOR ART

An excellent example of a shank hook configuration augmented with a flange is taught by Mr. Wong Hong in U.S. Pat. No. 5,549,234. In ‘234’ Hong discloses a hanger that is installed with a specialized tool. The hanger has a shank having a sharp point on one end, and an integrally formed hook on the other, with a flange medially disposed between, said flange extending radially around the shank. When installed, the tool drives the sharp end of the shank into the supporting surface until the flange comes into flush contact, thereby increasing the shank's load capacity at the hook end. Hong however necessarily requires a tool to secure or install the shank into the supporting surface, and once installed, the hanger is not reusable. Further, Hong does not anticipate, imply or teach a shank that if over loaded, sheers prior to causing damage to the supporting surface.

### SUMMARY OF INVENTION

To realize the above mentioned objects and other advantages the present invention provides a reusable hanger system comprising a metal shank having a point on one end and a hook on the other, with a specially formed detent medially located between the point and the hook, and a flange that encases the detent and fixates to the shank. The detent provides improved adhesion between the flange and the shank, while further providing a sheer point along the shank, thereby reducing damage to the supporting surface if a user overloads the hook. The flange serves several purposes, it is the finger push location for the user to install the hanger without tools, by pushing and/or twisting the flange such that the point pierces the support surface and inserts until the flange stops flush against the support surface. Once flush, the flange provides added support structure to the shank, thereby increasing loading capacities of the hook. When being removed, the flange provides finger twist and pull location that enables the user to remove the hanger leaving only a small hole matching the shank. Once removed, the hanger is ready to be used again.

The shank may be of any diameter so long as the diameter does not exceed the tolerated hole size in the mounting surface. In other words, if the hole must be small, then the shank diameter must be small.

The detent on the shank must be substantial enough to provide adequate fixation of the flange to the shank, while at the same time not cause structural failure of the shank during install or removal.

The flange may be of any shape or form. The flange serves multiple purposes; first, it provides a location for the user to push against when piercing into the supporting surface, thereby making for easy install of the hanger. Second, the flange controls the depth of the shank insert so the user only needs to push the hanger into the supporting surface until the flange comes into controlling contact. Third, the flange greatly increases the load capacity of the hook by contacting the supporting surface, securing the shank within the entry hole, and supporting the shank to prevent drooping or pulling out.

These and other features of the present invention will become readily apparent upon further review of the following specification and drawings.

### BRIEF DESCRIPTION OF DRAWINGS

FIG. 1 is a side cutaway side view of one embodiment of the reusable hanger system engaged in a supporting surface;

FIG. 2 is an illustrative perspective view of the reusable hanger;

FIG. 3 a cutaway side view of the preferred embodiment;

FIG. 4 shows a front cutaway front view of the preferred embodiment;

FIG. 5 is a cut away close up side view of the preferred embodiment;

FIG. 6 is a perspective view of the hanger with square flange.

Similar reference characters denote corresponding features consistently throughout the attached drawings and descriptions.

### DETAILED DESCRIPTION OF DRAWINGS

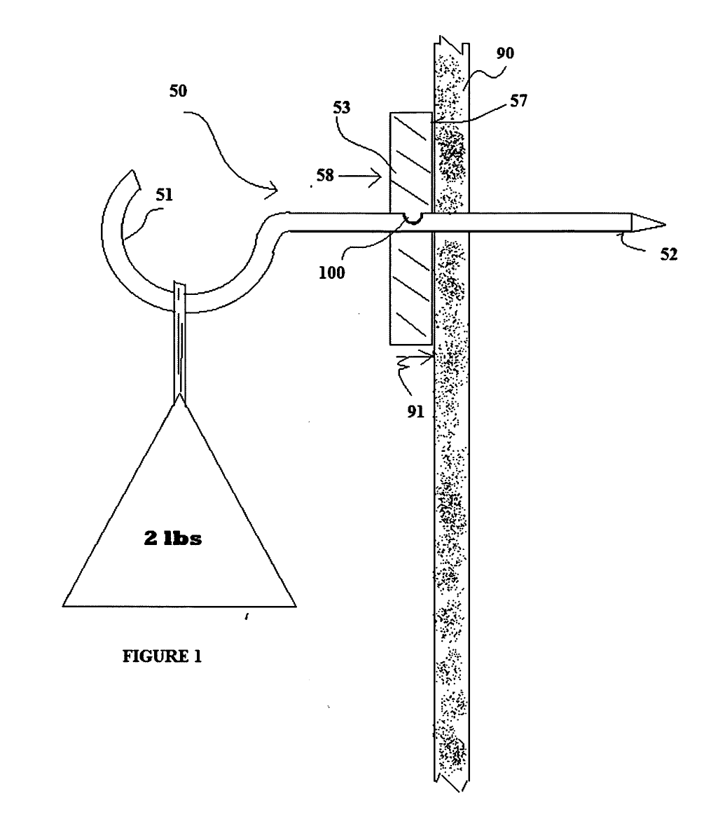

The present invention is a reusable hanger system 50 as shown in side cutaway view of FIG. 1 engaged through a supporting surface 90 supporting an illustrative 2 pound triangle. Push pin hangers having flanges in the prior art commonly failed structurally when installed by hand because the user pushes or twist with their fingers the flange 53 on the push side 58 to insert the shank 52 into the supporting surface 90 and the adhesion surface between the shank 52 and the flange 53 would not hold the push or twisting force, and the flange 53 would break away sliding down the shank 52. Even when the flange 53 held for one install, when being removed from the supporting surface 90 the twisting motion of removal would invariably break the flange 53 loose from the shank 52. If the flange 53 breaks loose it slides up the shank 52 making the hanger 50 unusable, as the flange 53 is necessary to work in cooperation with the shank 52 to support the weight applied at the hook 51 by compressively bracing 91 against the supporting surface 90 thereby securing the hanger 50 without tearing out or enlarging the hole through the supporting surface 90.

The hook 51 in the preferred embodiment is round, allowing for the hanging of many types of objects. However, a V shaped hook 51 may be desirable in other embodiments, as well as other hook shapes for specific applications.

Another prior art problem was the flange 53 not staying fixated to the shank 52 after engagement through the supporting surface 90 and when weight was applied to the hook 51 the forces pulling down on the hook 51 would cause the stop side 57 to press against the supporting surface 90, and if the downward force was great enough the flange 53 would break away from the shank 52, and slide up the shank 52, away from the supporting surface 90, allowing the shank 52 to droop, or slide out, causing the whole hanger 50 to tear out of the supporting surface 90 causing damage and making the pierce location through the supporting surface 90 unusable in the future.

The present invention solves the problems of the prior art improving upon the prior push pin designs by incorporating at least one detent 100 integral to the shank 52, and encased by the flange 53. The preferred embodiment detent 100 as shown is a cold formed metal deformity having a radius approximately half of the diameter of the shank, but the detent 100 may be less of a deformity, or be bulge as caused by compression at the detent 100 location. In other embodiments, the detent 100 is created by point source heat like a torch or by welding additional metal to the shank 52. The detent 100 increases the shank 52 surface area available for flange 53 adhesion, which increases the strength of the hanger 50 in total, while greatly increasing the weight bearing potential at the hook 51.

The detent 100 location shown in FIG. 1 is aligned with the hook 51, thereby providing a sheer point that structurally fails prior to tearing the shank 52 from the supporting surface 90. This preferred alignment reduces damage to the supporting surface 90 if the user overloads the hook 51. Upon overloading, the shank 52 fails at the detent 100 location, the hook 51 end of the shank 52 pulls out of the flange 53, leaving the flange 53 and remainder of shank 52 engaged with the supporting surface 90. The hanger 50 is relatively inexpensive when compared to repairing holes in supporting surfaces 90, as finished and painted sheet rock is an expected supporting surface 90 in which the hanger 50 would most likely be engaged.

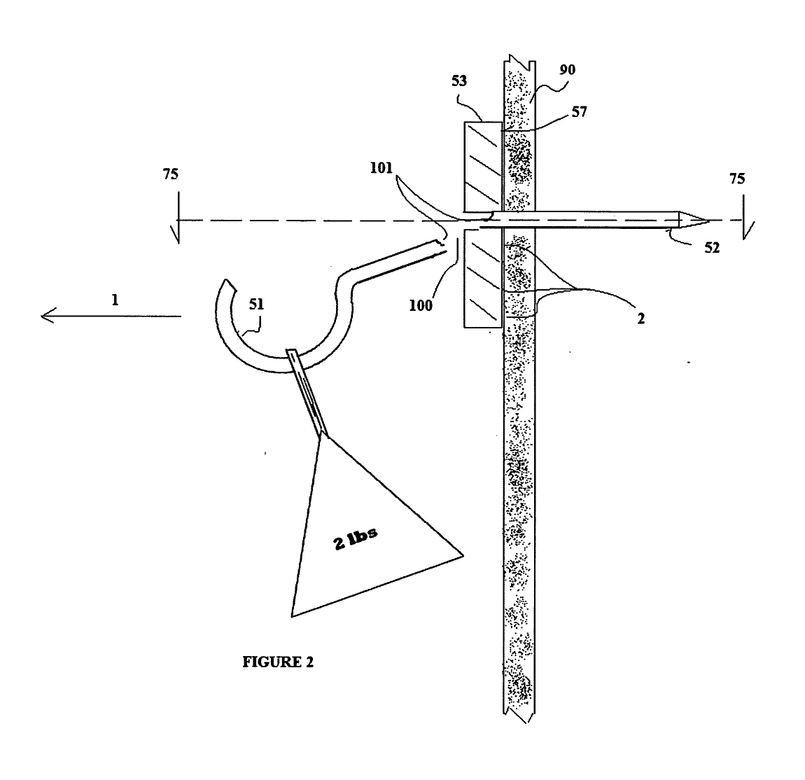

The detent 100 may be located 90 degrees around on either side of the shank 52, which provides increased strength, but is more likely to cause damage to the supporting surface if the hook 51 is overloaded. As illustrated in FIG. 2, the shank 52 is weakened by the integral detent 100, which is critical to control where the shank 52 fails, as it is by design to fail within the flange 53.

As illustrated in FIG. 2, when overloaded, the flange 53 protects the supporting surface 90 in two ways. First, if the hanger 50 is overloaded it breaks apart and sheers 101 within the flange 53 at the encased detent 100 location, which promotes the sheered 101 ends to separate, promoting the hook 51 to fall away 1 harmlessly from the supporting surface 90. Second, the area is protected 2 behind the flange 53 below the shank mid-line 75 that usually receives damage when a shank hook of this type is overloaded.

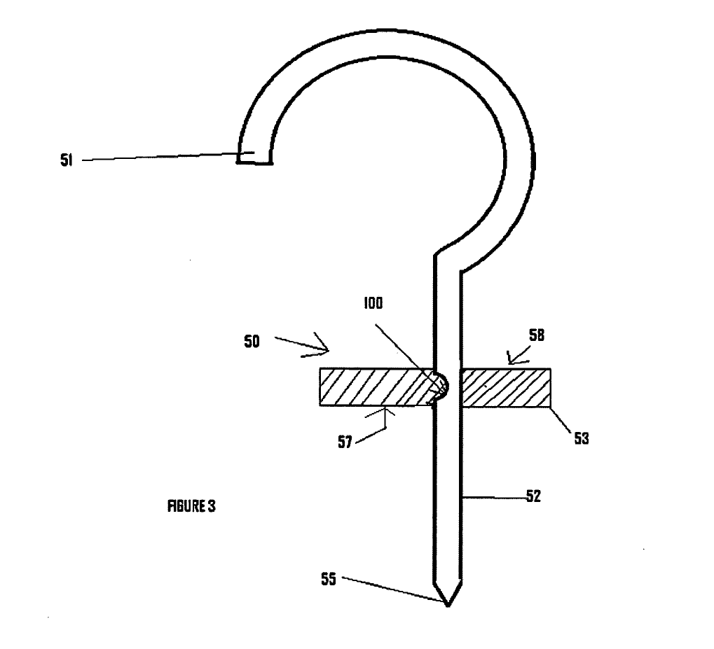

As shown in FIGS. 1-3, the flange 53 stops the penetration of the shank 52 into the supporting surface 90 when the stop side 57 of the flange 53 is flush with the supporting surface 90. Once installed, the hook portion 51 shown in FIG. 3 is ready to support objects, such as plant vines, signs, pictures, keys, etc. upon the supporting surface 90. When the hanging device 50 is repositioned or removed from the supporting surface 90 the damage to the supporting surface is only a small pinhole, and the small pinhole may be used again in the future as an install location.

Referring to FIG. 3 a cutaway side view of the preferred embodiment of the hanger 50, illustrates that the hanger 50 is a combination of a flange 53 and a shank 52 having a hook 51 at one end and a sharp point 55 at the end of the shank 52 opposite the hook 51, a detent 100 is located medially between the point 55 and the hook 51. The flange 53 also located medially along the shank 52 encases the detent 100, and mechanically fixates to the detent 100 and the shank 52. Having the flange 53 ‘encase’ detent 100 means completely cover and surround.

In the preferred embodiment, the flange 53 is of sufficient size and flat shape so as to make for painless install when pushing, and one inch of surface area greatly improves ease of use. The flange 53 may be enhanced tactilely by adding dimples, ridges, or gripper detents. The flange 53 is injection molded over and around the detent 100 which provides adequate mechanical contact and permanently fixates without the necessity of additional adhesives, glues, chemical or further process such as vulcanization. With the detent 100 providing the increase in necessary holding structure for the flange 53 as adhered to the shank 52, the flange 53 can be utilized to insert into the supporting surface 90 by putting finger pressure on the push side 58 of the flange 53, and twisting if necessary to assist install. If in other embodiments a threaded shank 53 is used, the flange 53 can be used to assist in screwing in the hanger 50. Glues and adhesives may be used rather than injection molding the flange 53 around the detent 100. The detent 100 increases mechanical contact with the flange 53 while further providing a structure for the flange 53 that is perpendicular to the direction of the push when installing, and resistive to a twist when removing.

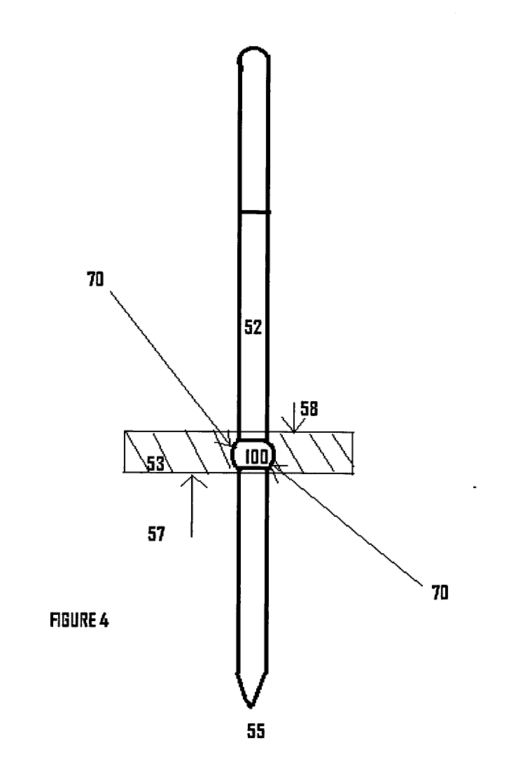

FIG. 4 shows a front cutaway front view of the preferred embodiment of the hanger 50. Preferably, the flange 53 extends radially 360 degrees around the shank 52 as shown, completely encasing the detent 100 including the deformed metal 70 that bulges past the shank's 52 original diameter, or in other words, the deformed metal 70 bulges past the width of the shank 52. The flange 53 is fixed to the shank 52 and the detent 100 by any suitable means, such as injection mold in place, by glue or other type of adhesive bonding when a plastic flange 53 is used.

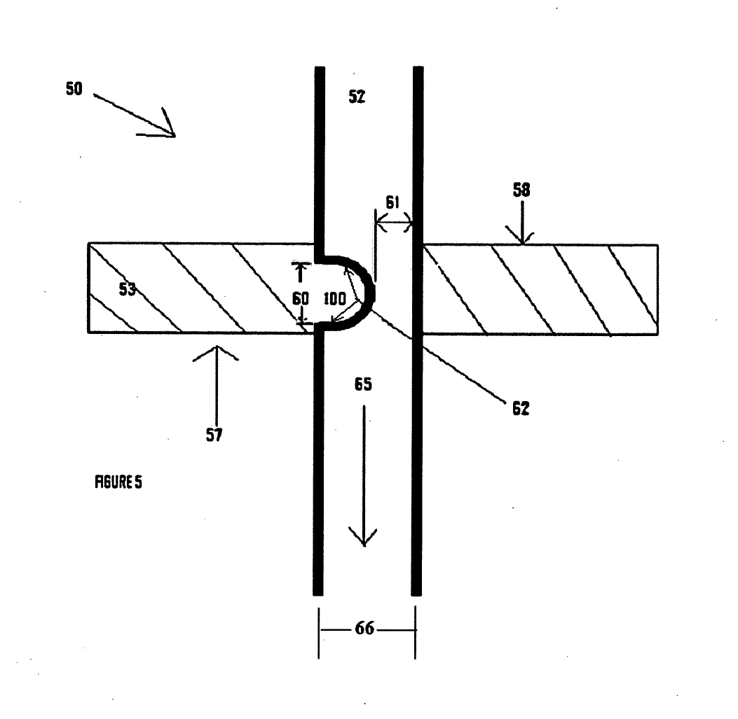

Shown in FIG. 5 is a cut away close up side view of the preferred embodiment of FIG. 3, centered on the shank 52, detent 100, and flange 53. The shank 52 as shown is a formed wire of consistent diameter 66, which is smooth along its length except at the detent location 100, thereby allowing easy insertion and removal from crumbly support surfaces. Only one detent 100 is shown, when in practice a plurality of detents 100 may be employed to increase fixation between the shank 52 and flange 53. Detents 100 may also be located on opposing sides of the shank 52, staggered from one another depending on the thickness of the flange 53. For example, if the flange 53 was thick, a second detent 100 may be added to increase adhesion and promote securement of the flange 53 to the shank 52. Knurling or surface treatment of the detent 100 can be performed to further increase adhesions as between the flange 53 and the detent 100, however, additional surface treatment is not necessary in most applications.

The detent 100 is preferably shown in a cutaway view in FIG. 5 as having a vertical opening 60 that is not greater than the unformed material 61 of the shank 52. The detent surface area 62 provides necessary fixation surface area for the flange 53, while providing a structure for the flange 53 to fill when injection molded, or permanently adhere using glues or adhesives. The detent 100 further provides a structure that is perpendicular to the longitudinal direction 65 of force applied to the push side 58, thereby preventing the flange 53 from sliding down the shank 52, or sliding up the shank 52 when downward forces are applied at the hook 51. As discussed earlier, the detent 100 also prevents the flange 53 from breaking away from the shank 52 if twisted while being removed.

Also of importance, the unformed material 61 may be increased or decreased depending on the desired sheer strength of the shank 52 at the detent location 100. As mentioned earlier, it is desirable for the shank 52 to fail at the detent 100 location if too much weight is applied at the hook 51, rather than the shank 52 remaining intact and tearing out the insert hole through the supporting surface 90.

For the preferred embodiment in FIG. 4, the detent 100 is rounded, having a radius matching the shank 52, and constructed and arranged such that the remainder material 61 is half of the diameter 66 of the shank 52. The amount of remainder material 61 required depends on application, as the bigger the detent 100, the less remainder material 61, and the more likely the shank 52 will fail when the hook 51 is loaded. Conversely, by increasing the size of the detent 100, or increasing the number of detents 100, the greater mechanical fixation of the flange 53 to the shank 52.

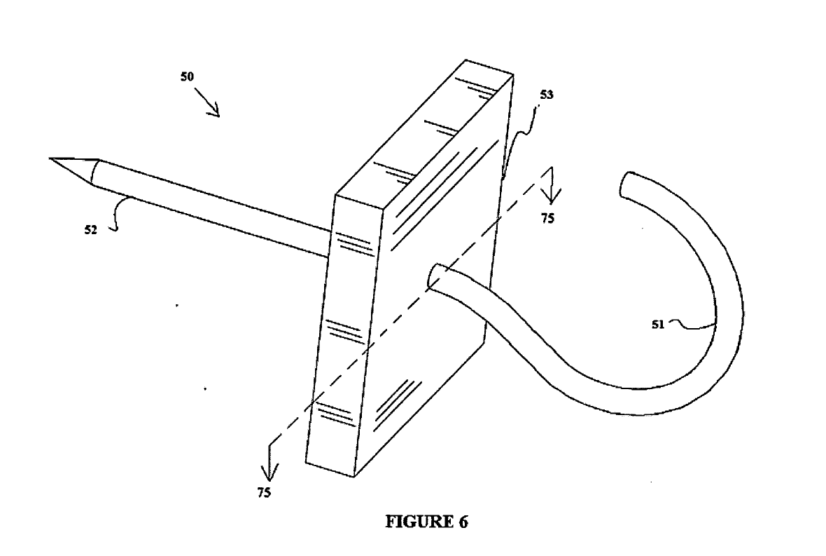

In FIG. 6 the hanger 50 is shown with a square flange 53. The flange 53 shape is an ornamental option, and may be round, heart, diamond, or any shape so long as the surface area of the flange 53 below the shank mid-line 75 is adequate for the loads applied to the hook 51. The greater the surface area of the flange 53 that is available to compressively brace 91 against the supporting surface 90 as shown in FIG. 1, the more weight the hook 51 may support without causing damage to the supporting surface. If the flange 53 is centered upon the shank 52, a minimum of a ¼ square inch is necessary when sheet rock is the supporting surface.

It is to be understood that the present invention is not limited to the embodiments described above, but encompasses any and all embodiments within the scope of the following claims.

I claim:

1. A reusable hanger that inserts and removes from a mounting surface without tools comprising:
a wire shank with consistent diameter having a point on one end, a hook integrally formed on the other, and at least one detent medially located between the point and the hook such that the wire shank is weakest at the detent location; and
a flange constructed and arranged to encase the at least one detent.

2. A reusable hanger that inserts and removes from a mounting surface without tools comprising:
a wire shank having a point on one end, a hook integrally formed on the other, and at least one detent medially located between the point and the hook;
the at least one detent integrally formed from the shank such that the vertical opening of the detent is no greater than the radius of the shank; and
a flange constructed and arranged to encase the at least one detent.

3. A reusable hanger that inserts and removes from a mounting surface without tools comprising:
a wire shank having a point on one end, a hook integrally formed on the other, and at least one detent medially located between the point and the hook;
the at least one detent formed by compressing the wire shank; and
a flange constructed and arranged to encase the at least one detent.

4. A reusable hanger that inserts and removes from a mounting surface without tools according to claim 1, 2, and 3, wherein the point, hook, and the at least one detent are formed from a single piece of metal.

5. A reusable hanger that inserts and removes from a mounting surface without tools according to claim 1, 2, and 3, wherein the flange is injected molded directly around the detent and shank.

6. A reusable hanger that inserts and removes from a mounting surface without tools according to claim 1, 2, and 3, wherein the shank is smooth between the flange and the point.

7. A reusable hanger that inserts and removes from a mounting surface without tools according to claim 1, 2, and 3, wherein the shank is threaded between the flange and the point.

8. A reusable hanger that inserts and removes from a mounting surface without tools according to claim 1, 2, and 3, wherein the flange extends radially from said shank 360°.

9. A reusable hanger that inserts and removes from a mounting surface without tools according to claim 1, 2, and 3, wherein the flange is constructed and arranged to provide no less than one square inch of surface area against the mounting surface.

10. A reusable hanger that inserts and removes from a mounting surface without tools according to claim 1, 2, and 3, wherein the flange is constructed and arranged to include dimples, ridges, or gripper detents on its surface.

11. A reusable hanger that inserts and removes from a mounting surface without tools according to claim 1, 2, and 3, wherein the flange is constructed in a fanciful shape.

12. A reusable hanger that inserts and removes from a mounting surface without tools according to claim 1, 2, and 3, wherein the hook is round in shape, open at the top.

13. A reusable hanger that inserts and removes from a mounting surface without tools according to claim 1, 2, and 3, wherein the hook is shaped like a ‘V’.
